(19) United States
(12) Patent Application Publication
(10) Pub. No.: US 2024/0385211 A1
(43) Pub. Date: Nov. 21, 2024

(54) MICROELECTROMECHANICAL ACCELERATION SENSOR, AND METHOD FOR OPERATING A MICROELECTROMECHANICAL ACCELERATION SENSOR

(71) Applicant: Robert Bosch GmbH, Stuttgart (DE)

(72) Inventors: Zsombor Cseke, Budapest (HU); Amin Jemili, Kusterdingen (DE); Monika Koster, Reutlingen (DE)

(21) Appl. No.: 18/631,450

(22) Filed: Apr. 10, 2024

(30) Foreign Application Priority Data
May 15, 2023 (DE) 10 2023 204 516.8

(51) Int. Cl. G01P 15/125

(52) U.S. Cl. CPC G01P 15/125

(57) ABSTRACT

A microelectromechanical acceleration sensor. The sensor includes a substrate and a first and a second rocker. The rockers are each connected via spring elements to anchorages arranged on the substrate and are mounted rotatably about an axis of rotation extending in parallel with the substrate. Relative to the axis of rotation, the first rocker has an asymmetrical mass distribution and the second rocker has a symmetrical mass distribution. The first rocker has a frame structure having a symmetrical mass distribution and an additional mass. The frame structure has a first frame and a second frame. The frames are arranged on opposite sides of the axis of rotation. The first frame surrounds a first recess. The additional mass is arranged in the first recess and is connected to the first frame via additional spring elements.

### CROSS REFERENCE

The present application claims the benefit under 35 U.S.C. § 119 of German Patent Application No. DE 10 2023 204 516.8 filed on May 15, 2023, which is expressly incorporated herein by reference in its entirety.

### FIELD

The present invention relates to a microelectromechanical acceleration sensor and a method for operating a microelectromechanical acceleration sensor.

### BACKGROUND INFORMATION

Microelectromechanical acceleration sensors are described in the related art. Due to tensions that can occur in such sensors, an acceleration signal can have an undesired error or offset.

Methods for compensating for such an offset are described in the related art. For example, it is possible to reduce deformations by selecting the materials of a microelectromechanical acceleration sensor. It is also advantageous, for example, to favor thicker chips over thinner chips. Furthermore, geometries of electrodes and/or anchors of electrodes can be optimized in order to reduce tensions.

### SUMMARY

An object of the present invention is to provide an improved microelectromechanical acceleration sensor and to present an improved method for operating a microelectromechanical acceleration sensor. This object may be achieved by a microelectromechanical acceleration sensor and a method for operating a microelectromechanical acceleration sensor having features of the present invention. Advantageous developments and example embodiment of the present invention are disclosed herein.

A microelectromechanical acceleration sensor according to an example embodiment of the present invention has a substrate, a first rocker and a second rocker. The first rocker is connected via first spring elements to a first anchorage arranged on the substrate and is mounted rotatably about an axis of rotation extending in parallel with the substrate. The second rocker is connected via second spring elements to a second anchorage arranged on the substrate and is mounted rotatably about the axis of rotation. The first rocker has an asymmetrical mass distribution relative to the axis of rotation. The second rocker has a symmetrical mass distribution relative to the axis of rotation. The first rocker has a frame structure having a symmetrical mass distribution and an additional mass. The frame structure has a first frame and a second frame. The first frame and the second frame are arranged on opposite sides of the axis of rotation relative to a direction perpendicular to the axis of rotation and parallel to the substrate. The first frame surrounds a first recess and the second frame surrounds a second recess. The additional mass is arranged in the first recess and is connected to the first frame via additional spring elements.

Due to its rocker structure, the microelectromechanical acceleration sensor is designed to measure acceleration forces with a component in a direction perpendicular to the substrate. Due to the asymmetrical mass distribution of the first rocker, a rotation of the first rocker about the axis of rotation is brought about when a force acts perpendicularly to the substrate. Since tensions can occur in the microelectromechanical acceleration sensor, an acceleration signal provided by means of the first rocker can have an offset.

In contrast, the second rocker has a symmetrical mass distribution relative to the axis of rotation. For this reason, the second rocker is insensitive to acceleration forces. However, it makes it possible to detect signals which occur solely due to tensions in the microelectromechanical acceleration sensor. For this reason, a compensation signal for compensating for an offset of an acceleration signal generated by means of the first rocker can be provided by means of the second rocker, as a result of which the offset in the acceleration signal can be eliminated. The second rocker therefore forms a tension detection element of the microelectromechanical acceleration sensor. The signal of the second rocker is ideally the same as the offset signal of the acceleration sensor. This compensation can take place both on analog and on digital levels.

Advantageously, according to an example embodiment of the present invention, the first rocker is also designed symmetrically in terms of tensions due to the frame with symmetrical mass distribution like the second rocker. This advantageously ensures that the first rocker and the second rocker bend equally when tensions occur in the microelectromechanical acceleration sensor. An offset in the acceleration signal due to tensions can be compensated for particularly well in this way. The mass asymmetry of the first rocker is ensured by the additional mass. This is suspended into the frame of the first rocker, wherein the additional spring elements are used in order to decouple the additional mass from tensions.

In one example embodiment of the present invention, the first anchorage and the second anchorage are arranged along the axis of rotation. Advantageously, tensions that act on the first and the second rocker can be similar in nature, as a result of which particularly effective compensation for the acceleration signal is enabled.

In one example embodiment of the present invention, the first anchorage has two first anchors arranged along the axis of rotation. The second anchorage has two second anchors arranged along the axis of rotation. Two first spring elements each connect the first rocker to a first anchor, and two second spring elements each connect the second rocker to a second anchor. Advantageously, the arrangement of the anchors along the axis of rotation allows an integration or embedding of the second rocker into the first rocker.

In one example embodiment of the present invention, the first and the second spring elements extend in a meandering manner in a direction perpendicular to the axis of rotation and parallel to the substrate. Advantageously, the arrangement of the anchors along the axis of rotation and the meandering arrangement of the spring elements allows the second rocker to be easily embedded in the first rocker.

In one example embodiment of the present invention, the first rocker has a recess in the region of the axis of rotation. The second rocker is arranged in the recess of the first rocker. The second rocker is therefore integrated in the first rocker. The first rocker and the second rocker are arranged in a common plane, and the first rocker laterally encloses the second rocker. In this arrangement, the anchorages of the rocker are arranged within a region of the recess of the first rocker and thereby particularly close to one another, as a result of which tensions acting on the first and second rocker are particularly similar.

In one example embodiment of the present invention, the microelectromechanical acceleration sensor has a first electrode fixedly arranged on the substrate and a second electrode fixedly arranged on the substrate. The second rocker has an additional first frame and an additional second frame. The additional first frame and the additional second frame are arranged relative to a direction perpendicular to the axis of rotation and parallel to the substrate on opposite sides of the axis of rotation. The additional first frame surrounds an additional first recess, and the additional second frame surrounds an additional second recess. The first fixed electrode is arranged in the additional first recess, and the second fixed electrode is arranged in the additional second recess.

Due to the fact that different anchorages are used for the first rocker and the second rocker, the fixed electrodes can function as counter electrodes both for the first rocker and for the second rocker. The first rocker and the fixed electrodes therefore each form electrical capacitances which serve as measurement signals for measuring the acceleration including an offset due to tensions. Likewise, the second rocker with the fixed electrodes forms electrical capacitances which serve as a measurement signal for measuring tensions. With the same stationary electrodes, a plurality of signals can accordingly be generated, as a result of which the microelectromechanical acceleration sensor is particularly compact since no separate fixed electrodes have to be provided for the second rocker.

In one example embodiment of the present invention, first movable electrodes connected to the first rocker and second movable electrodes connected to the second rocker are arranged between the substrate and the rockers. The first movable electrodes are arranged in the region of the recesses of the frame of the first rocker and are connected to the frame of the first rocker. The second movable electrodes are arranged in the region of the additional recesses of the additional frames of the second rocker and are connected to the additional frames. The movable electrodes form electrical capacitances with the fixed electrodes.

According to an example embodiment of the present invention, a method for operating a microelectromechanical acceleration sensor with a substrate, a first rocker and a second rocker, wherein the first rocker is connected to a first anchorage arranged on the substrate via first spring elements and is mounted rotatably about an axis of rotation extending in parallel with the substrate, and the second rocker is connected via second spring elements to a second anchorage arranged on the substrate and is mounted rotatably about the axis of rotation, and wherein the first rocker has an asymmetrical mass distribution relative to the axis of rotation, and the second rocker has a symmetrical mass distribution relative to the axis of rotation, wherein the first rocker has a frame structure having a symmetrical mass distribution and an additional mass, wherein the frame structure has a first frame and a second frame, wherein the first frame and the second frame are arranged on opposite sides of the axis of rotation relative to a direction perpendicular to the axis of rotation and parallel to the substrate, wherein the first frame surrounds a first recess and the second frame surrounds a second recess, wherein the additional mass is arranged in the first recess and is connected to the first frame via additional spring elements, comprises the following method steps. A first signal is detected by means of the first rocker. A second signal is detected by means of the second rocker. The first signal is corrected by means of the second signal.

The microelectromechanical acceleration sensor according to an example embodiment of the present invention is described in detail below in conjunction with the figures.

### BRIEF DESCRIPTION OF THE DRAWINGS

FIG. 1 shows a micro-electromechanical acceleration sensor in a plan view, according to an example embodiment of the present invention.

FIG. 2 shows a detail of the microelectromechanical acceleration sensor according to FIG. 1 in a plan view.

FIG. 3 shows a first rocker of the microelectromechanical acceleration sensor of FIG. 1 in a perspective view.

FIG. 4 shows a second rocker of the microelectromechanical acceleration sensor of FIG. 1 in a perspective view.

FIG. 5 shows a layer structure of the microelectromechanical acceleration sensor of FIG. 1 in a perspective view.

### DETAILED DESCRIPTION OF EXAMPLE EMBODIMENTS

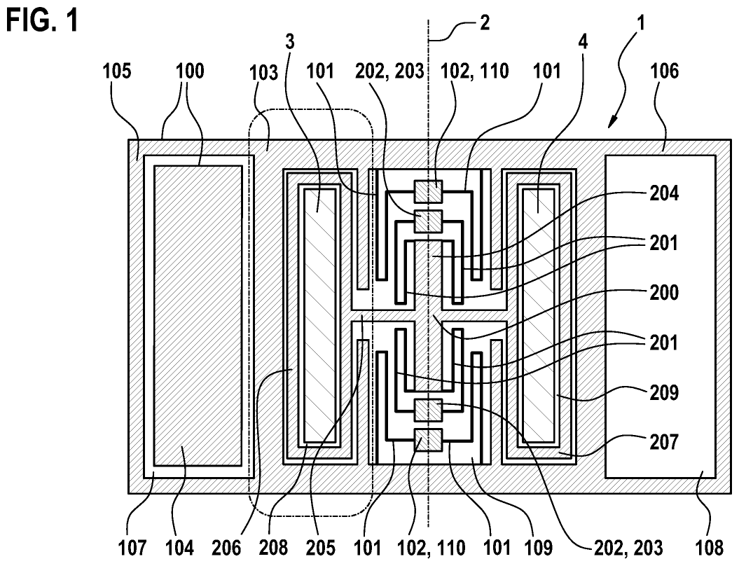

FIG. 1 shows a schematic plan view of a microelectromechanical acceleration sensor 1.

The microelectromechanical acceleration sensor 1 has a substrate, a first rocker 100, and a second rocker 200. The substrate is not shown in FIG. 1 for simplicity and for clarity. The first rocker 100 is connected via first spring elements 101 to a first anchorage 102 arranged on the substrate and mounted rotatably about an axis of rotation 2 extending in parallel with the substrate. The second rocker 200 is connected via second spring elements 201 to a second anchorage 202 arranged on the substrate and mounted rotatably about the axis of rotation 2. The first anchorage 102 and the second anchorage 202 are arranged on an upper side of the substrate, whereby the rockers 100, 200 are arranged above the upper side. The first rocker 100 and the second rocker 200 therefore have different anchorages 102, 202, but at least rotary axes 2 extending in parallel with one another. In particular, the first rocker 100 and the second rocker 200 have the same axis of rotation 2 as FIG. 1 shows by way of example.

The first rocker 100 has an asymmetrical mass distribution relative to the axis of rotation 2. The second rocker 200 has a symmetrical mass distribution relative to the axis of rotation 2. FIG. 1 shows by way of example that the mass asymmetry of the first rocker 100 relative to the axis of rotation 2 is established by the fact that the rocker 100 has a frame structure 103 having a symmetrical mass distribution and an additional mass 104. The frame structure 103 has a first frame 105 and a second frame 106. The first frame 105 and the second frame 106 are arranged on opposite sides of the axis of rotation 2 relative to a direction perpendicular to the axis of rotation 2 and parallel to the substrate. The first frame 105 surrounds a first recess 107, and the second frame 106 surrounds a second recess 108. The additional mass 104 is arranged in the first recess 107. The additional mass 104 is connected to the first frame 105 via additional spring elements which are not shown in FIG. 1 for the sake of simplicity. The additional mass 104 is thereby suspended on the first frame 105 in the region of the first recess 107. As a result, the first rocker 100 has the asymmetrical mass distribution.

Due to the asymmetrical mass distribution, the first rocker 100 is made to rotate about the axis of rotation 2 when acceleration with a component perpendicular to the substrate acts on the microelectromechanical acceleration sensor 1. By contrast, the second rocker 200 has a symmetrical mass distribution. For this reason, the second rocker 200 is insensitive to accelerations in a direction perpendicular to the substrate. However, the first rocker 100 and the second rocker 200 are subjected to tensions which can occur in the microelectromechanical acceleration sensor. Tensions occur in particular at interfaces between different materials with different thermal expansion coefficients. This means that a tension signal can be superimposed on an acceleration signal from the first rocker. However, a signal of the second rocker 200 does not comprise any acceleration components, but only tension components. The second rocker 200 is therefore provided to provide a tension signal which can be used to compensate for the acceleration signal of the first rocker 100.

The microelectromechanical acceleration sensor of FIG. 1 with the first rocker 100, which has a frame structure 103 having a symmetrical mass distribution and an additional mass 104, offers the advantage that the first rocker 100 and the second rocker 200 react very similarly to tensions. Thus, tension artifacts in the acceleration signal of the first rocker 100 can be effectively compensated for.

In contrast to the representation in FIG. 1, the first rocker 100 and the second rocker 200 can be arranged laterally next to one another on the substrate. Embedding the second rocker 200 in the first rocker 100, as shown in FIG. 1, makes it possible, however, for the first rocker 100 and the second rocker 200 to react in a particularly similar manner to tensions. For this purpose, the first rocker 100 has a recess 109 in the region of the axis of rotation 2. The second rocker 200 is arranged in the recess 109 of the first rocker.

In order to enable a rotation of the first rocker 100 and the second rocker 200 about a common axis of rotation 2, the anchorages 102, 202 can be arranged as shown in FIG. 1. In this case, the first anchorage 102 and the second anchorage 202 are arranged along the axis of rotation 2. However, it is also possible for the first rocker 100 and the second rocker 200 to have parallel axes of rotation 2. In this case, the anchorages 102, 202 are not arranged along a common axis of rotation 2.

In order to enable a stable rotation of the first rocker 100 and the second rocker 200 about the axis of rotation 2, it is expedient to provide the anchorages 102, 202 in each case with a plurality of anchors 110, 203, i.e. in each case at least two anchors 110, 203. By way of example, the first anchorage 102 has two first anchors 110 arranged along the axis of rotation 2. The second anchorage 202 has, also by way of example, two second anchors 203 arranged along the axis of rotation 2.

For example, two first spring elements 101 each connect the first rocker 100 to a first anchor 110, and two second spring elements 201 each connect the second rocker 200 to a second anchor 203. The first rocker 100 is therefore connected by means of four first spring elements 101 to two first anchors 110. The second rocker 200 is connected to two second anchors 203 by means of four second spring elements 201. Only one spring element 101, 201 can also be provided per anchor 110, 203. The spring elements 101, 201 are formed as torsion springs.

The first spring elements 101 connect the first anchors 110 to a portion of the frame structure 103 of the first rocker 100 extending perpendicularly to the axis of rotation 2. The second spring elements 201 connect the second anchor 203 to a portion 204 of the second rocker 200 extending in parallel with the axis of rotation 2. In addition to the portion 204 extending in parallel with the axis of rotation 2, the second rocker 200 has a portion 205 extending perpendicularly to the axis of rotation 2. Alternatively or additionally, the second spring elements 201 can also be connected to the portion 205 extending perpendicularly to the axis of rotation 2.

The first and the second spring elements 101, 201 extend in a meandering manner in a direction perpendicular to the axis of rotation 2 and parallel to the substrate. By way of example, the first and second spring elements 101, 201 each have a meander. For this reason, the spring elements 101, 201 can also be referred to as U-shaped. A rigidity of the spring elements 101, 201 can be influenced via a number of meanders, a total length of the spring elements 101, 201, their width and/or their thickness. However, it is not absolutely necessary for the spring elements 101, 201 to be meandering in design. It can also be sufficient if the spring elements 101, 201 are substantially designed as bar-shaped spring elements.

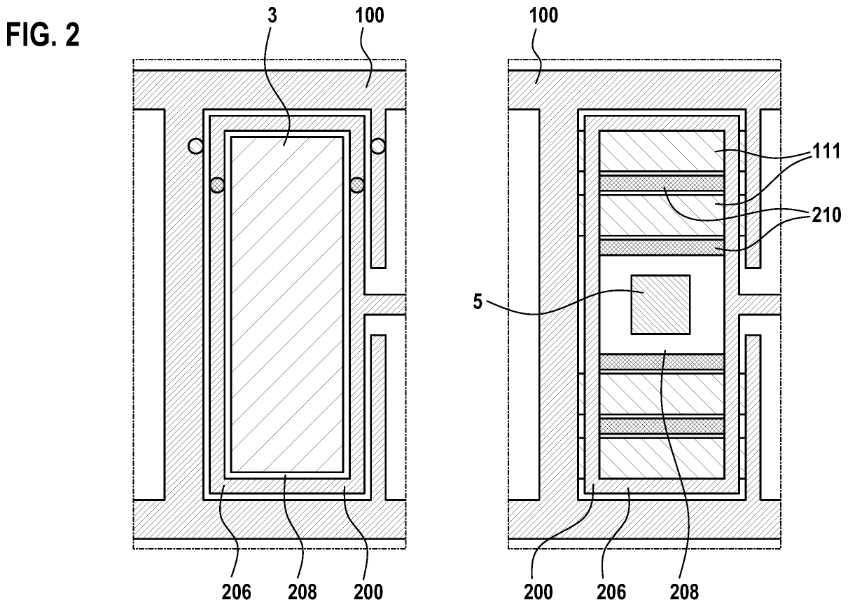

FIG. 2 shows a schematic plan view of a section of the microelectromechanical acceleration sensor 1 on the left side corresponding to an area marked with a dashed line in FIG. 1. The previously used reference signs are retained in the following description.

The microelectromechanical acceleration sensor 1 has a first electrode 3 fixedly arranged on the substrate, and a second electrode 4 fixedly arranged on the substrate. The second rocker 200 has an additional first frame 206 and an additional second frame 207. The additional first frame 206 and the additional second frame 207 are arranged on opposite sides of the axis of rotation 2 relative to a direction perpendicular to the axis of rotation 2 and parallel to the substrate. The additional first frame 206 and the additional second frame 207 are connected to one another via the portion 205 of the second rocker 200 extending perpendicularly to the axis of rotation 2. The additional first frame 203 surrounds an additional first recess 208, and the additional second frame 207 surrounds an additional second recess 209. The first fixed electrode 3 is arranged in the first additional recess 208, and the second fixed electrode 4 is arranged in the second additional recess 209. The first electrode 3 and the second electrode 4 are therefore arranged in a common plane with the first rocker 100 and the second rocker 200. The second fixed electrode 4 and the second additional frame 207 are not shown in FIG. 2, since only one region of the first additional frame 206, or the first fixed electrode 3 of the microelectromechanical acceleration sensor 1 is shown.

FIG. 2 shows a schematic plan view of the region of the microelectromechanical acceleration sensor 1 marked in FIG. 1 on the right side, wherein the first fixed electrode 3 is not shown in order to show elements of the microelectromechanical acceleration sensor 1 arranged between the substrate and the first fixed electrode 3. For example, an additional anchor 5 is shown in this view. The first electrode 3 is anchored to the additional anchor 5 and is thereby fixed relative to the substrate.

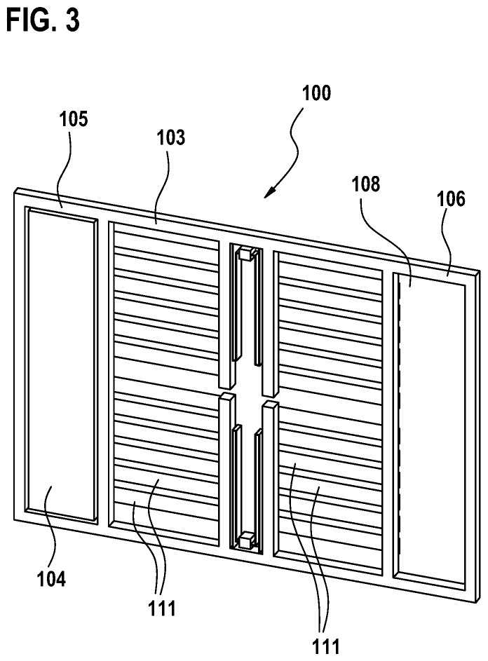

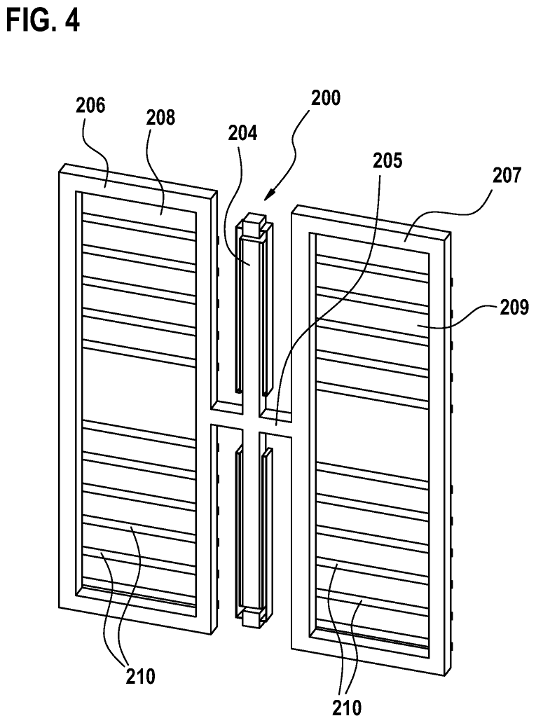

In addition to the fixed electrodes 3, 4, the microelectromechanical acceleration sensor 1 has first movable electrodes 111 and second movable electrodes 210 which are each arranged between the substrate and the rockers 100, 200. The first movable electrodes 111 are connected to the first rocker 100. The second movable electrodes 210 are connected to the second rocker 200. For the sake of clarity, FIG. 3 schematically shows the first rocker 100 in combination with the first movable electrodes 111 in a perspective view. FIG. 4 additionally schematically shows the second rocker 200 in combination with the second movable electrodes 111 in a perspective view. The previously used reference signs are retained in both cases.

The first movable electrodes 111 are arranged in the region of the recesses 107, 108 of the frames 105, 106 and are connected to the frames 105, 106 of the first rocker 100. The second movable electrodes 210 are arranged in the region of the additional recesses 208, 209 of the additional frames 206, 207 of the second rocker 200 and are connected to the additional frames 206, 207. The connection of the movable electrodes 111, 210 to the respective frames 105, 106, 206, 207 is indicated in FIG. 2 on the left side by means of dots shown in the region of the connections.

The movable electrodes 111, 210 extend in the direction perpendicular to the axis of rotation 2 and parallel to the substrate. Alternatively, the movable electrodes 111, 210 can also extend parallel to the axis of rotation 2. The first movable electrodes 111 and the second movable electrodes 210 are arranged, alternately, perpendicularly to their direction of extension, i.e. the first movable electrodes 111 and second movable electrodes 210 are arranged, alternately, perpendicularly to the direction of extension. An additional anchor 5 for the fixed electrodes 3, 4 is arranged in each case in the middle of the additional frames 206, 207. For this reason, no movable electrodes 111, 210 are arranged in the region of the additional anchors 5.

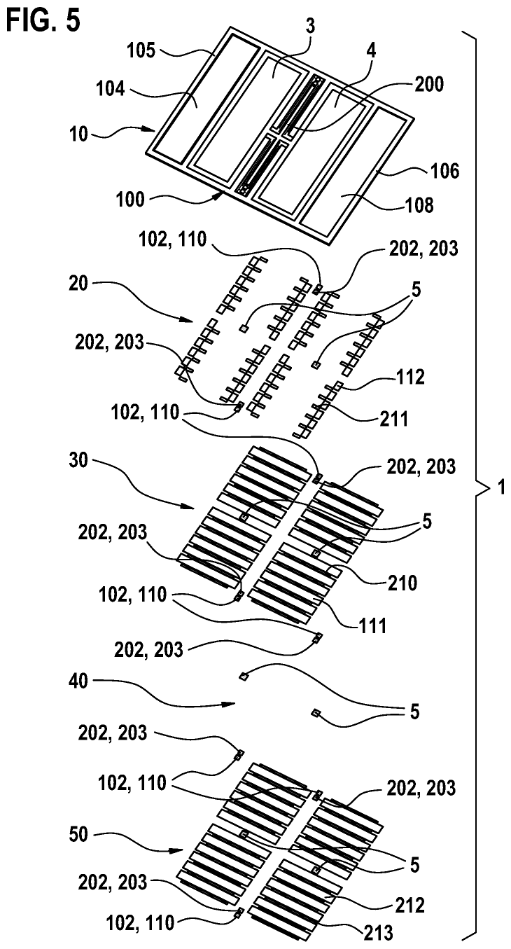

FIG. 5 schematically shows a layer structure of the microelectromechanical acceleration sensor 1 in a perspective view. The substrate is also not shown in FIG. 5. The previously used reference signs are retained in the following.

The first rocker 100, the second rocker 200 and the fixed electrodes 3, 4 are arranged in an uppermost first layer 10 facing away from the substrate. In a second layer 200, which is arranged between the substrate and the first layer 10, first connecting elements 112 are formed for connecting the first movable electrodes 111 to the first rocker 100, and second connecting elements 211 are formed for connecting the second movable electrodes 210 to the second rocker 200. The first and the second movable electrodes 111, 210 are formed in a third layer 30 which is arranged between the substrate and the second layer 20. Only the first anchors 110, the second anchors 203 and the additional anchors 5 are formed in a fourth layer 40 which is arranged between the substrate and the third layer 20. These are also formed in a fifth layer 50, which is arranged between the substrate and the fourth layer 40, and moreover also extend into the first, second and third layers 10, 20, 30. The fifth layer 50 is arranged on the substrate. Furthermore, in the fifth layer 50, fixed first counter electrodes 212 are provided on the substrate for the first movable electrodes 111, and fixed second counter electrodes 213 are provided on the substrate for the second movable electrodes 210.

In a method for operating the microelectromechanical acceleration sensor 1 according to one of the explained embodiments, a first signal is generated by means of the first rocker in a first method step. The first signal comprises acceleration and tension components. In a second method step, a second signal is generated by means of the second rocker. The second signal only comprises tension components, but no acceleration components. In a third method step, the first signal is corrected by means of the second signal. In this way, the tension components can be compensated for in the first signal.

What is claimed is:

1. A microelectromechanical acceleration sensor, comprising:
a substrate;
a first rocker; and
a second rocker;
wherein the first rocker is connected via first spring elements to a first anchorage arranged on the substrate and is mounted rotatably about an axis of rotation extending in parallel with the substrate, and the second rocker is connected via second spring elements to a second anchorage arranged on the substrate and is mounted rotatably about the axis of rotation;
wherein the first rocker includes an asymmetrical mass distribution relative to the axis of rotation and the second rocker has a symmetrical mass distribution relative to the axis of rotation;
wherein the first rocker includes a frame structure having a symmetrical mass distribution and an additional mass;
wherein the frame structure has a first frame and a second frame, wherein the first frame and the second frame are arranged on opposite sides of the axis of rotation relative to a direction perpendicular to the rotation axis and parallel to the substrate;
wherein the first frame surrounds a first recess and the second frame surrounds a second recess; and
wherein the additional mass is arranged in the first recess and is connected to the first frame via further spring elements.

2. The microelectromechanical acceleration sensor according to claim 1, wherein the first anchorage and the second anchorage are arranged along the axis of rotation.

3. The microelectromechanical acceleration sensor according to claim 2, wherein the first anchorage includes two first anchors arranged along the axis of rotation, wherein the second anchorage includes two second anchors arranged along the axis of rotation, and wherein two first spring elements each connect the first rocker to a first anchor of the two first anchors, and two second spring elements each connect the second rocker to a second anchor of the two second anchors.

4. The microelectromechanical acceleration sensor according to claim 3, wherein the first and the second spring elements extend in a meandering manner in a direction perpendicular to the axis of rotation and parallel to the substrate.

5. The microelectromechanical sensor according to claim 1, wherein the first rocker has a recess in a region of the axis of rotation, and wherein the second rocker is arranged in the recess of the first rocker.

6. The microelectromechanical acceleration sensor according to claim 1, further comprising:
a first electrode fixedly arranged on the substrate; and
a second electrode fixedly arranged on the substrate;
wherein the second rocker has an additional first frame and an additional second frame,
wherein the additional first frame and the additional second frame are arranged relative to a direction perpendicular to the axis of rotation and parallel to the substrate on opposite sides of the axis of rotation,
wherein the additional first frame defines an additional first recess, and the additional second frame defines an additional second recess, and
wherein the first fixed electrode is arranged in the additional first recess, and the second fixed electrode is arranged in the additional second recess.

7. The microelectromechanical acceleration sensor according to claim 6, wherein:
first movable electrodes connected to the first rocker and second movable electrodes connected to the second rocker are arranged between the substrate and the first and second rockers;
the first movable electrodes are arranged in a region of the first and second recesses of the first and second frames of the first rocker and are connected to the first and second frames of the first rocker; and
the second movable electrodes are arranged in a region of the additional first and second recesses of the additional first and second frames of the second rocker and are connected to the additional first and second frames.

8. A method for operating a microelectromechanical acceleration sensor, wherein the microelectromechanical acceleration sensor includes a substrate, a first rocker, and a second rocker, wherein the first rocker is connected via first spring elements to a first anchorage arranged on the substrate and is mounted rotatably about an axis of rotation extending in parallel with the substrate, and the second rocker is connected via second spring elements to a second anchorage arranged on the substrate and is mounted rotatably about the axis of rotation, wherein the first rocker has an asymmetrical mass distribution relative to the axis of rotation, and the second rocker has a symmetrical mass distribution relative to the axis of rotation, wherein the first rocker has a frame structure having a symmetrical mass distribution and an additional mass, wherein the frame structure has a first frame and a second frame, wherein the first frame and the second frame are arranged on opposite sides of the axis of rotation relative to a direction perpendicular to the axis of rotation and parallel to the substrate, wherein the first frame surrounds a first recess, and the second frame surrounds a second recess, wherein the additional mass is arranged in the first recess and is connected to the first frame via further spring elements, wherein the method comprises the following steps:
detecting a first signal using the first rocker;
detecting a second signal using the second rocker; and
correcting the first signal using the second signal.
